(19) United States
(12) Patent Application Publication
(10) Pub. No.: US 2021/0360236 A1
(43) Pub. Date: Nov. 18, 2021

(54) SYSTEM AND METHOD FOR ENCODING A BLOCK-BASED VOLUMETRIC VIDEO HAVING A PLURALITY OF VIDEO FRAMES OF A 3D OBJECT INTO A 2D VIDEO FORMAT

(71) Applicant: Omnivor, Inc., Seattle, WA (US)

(72) Inventors: Adam G. Kirk, Mercer Island, WA (US); Oliver A. Whyte, Seattle, WA (US)

(73) Assignee: Omnivor, Inc., Seattle, WA (US)

(21) Appl. No.: 17/334,769

(22) Filed: May 30, 2021

Related U.S. Application Data
(63) Continuation-in-part of application No. 16/872,259, filed on May 11, 2020, now Pat. No. 11,049,273.
Application No. 16/872,259 is a continuation-in-part of application No. 16/440,369, filed on Jun. 13, 2019, now Pat. No. 10,692,247.
Application No. 16/440,369 is a continuation-in-part of application No. 16/262,860, filed on Jan. 30, 2019, now Pat. No. 10,360,727.

(51) Int. Cl. H04N 19/115; H04N 19/186; H04N 19/176; H04N 19/172; H04N 19/119

(52) U.S. Cl. CPC H04N 19/115; H04N 19/186; H04N 19/119; H04N 19/172; H04N 19/176

(57) ABSTRACT

A processor-implemented method for encoding a block-based volumetric video having a plurality of video frames of a 3D object into a 2D video format is provided. The method including (i) splitting each video frame of the plurality of video frames into a first region that includes RGB data, a second region that includes depth data, and at least a third region containing render metadata of the 3D object; and (ii) storing the render metadata of the 3D object in at least one of the first region that includes the RGB data, the second region that includes the depth data and the at least the third region in at least one channel that is selected from a U chroma channel, a V chroma channel, and a luma channel of the block-based volumetric video.

### CROSS-REFERENCE TO RELATED APPLICATIONS

This patent application is a continuation-in-part of, and claims priority to, all the following including pending U.S. patent application Ser. No. 16/872,259 filed on May 11, 2020, which is a continuation-in-part of U.S. patent application Ser. No. 16/440,369 filed Jun. 13, 2019, now U.S. Pat. No. 10,692,247, which is a continuation-in-part of U.S. patent application Ser. No. 16/262,860 filed on Jan. 30, 2019, now U.S. Pat. No. 10,360,727, which is a continuation-in-part of PCT patent application no. PCT/US18/44826 filed on Aug. 1, 2018, U.S. non-provisional patent application Ser. No. 16/049,764 filed on Jul. 30, 2018, now U.S. Pat. No. 10,229,537, and U.S. provisional patent application No. 62/540,111 filed on Aug. 2, 2017, the complete disclosures of which, in their entireties, are hereby incorporated by reference.

### BACKGROUND

### Technical Field

Embodiments of this disclosure generally relate to encoding a block-based volumetric video, and more particularly, to a system and method for encoding the block-based volumetric video having a plurality of video frames of a 3D object into a 2D video format.

### Description of the Related Art

A volumetric video, or a free-viewpoint video, captures a representation of surfaces in 3-dimensional (3D) space and combines the visual quality of photography with the immersion and interactivity of 3D content. The volumetric video may be captured using multiple cameras to capture surfaces inside a defined volume by filming from one or more viewpoints and interpolating over space and time. Alternatively, the volumetric video may be created from a synthetic 3D model. One of the features of volumetric video is the ability to view a scene from multiple angles and perspectives in a realistic and consistent manner. Since the amount of data that has to be captured and streamed is huge as compared to non-volumetric video, encoding and compression play a key role in broadcasting the volumetric video. Each frame of a block-based volumetric video includes different types of data such as RGB data, depth data, etc. which have to be stored in the block-based volumetric video.

When encoding the block-based volumetric video in a 2D video format, a block may represent some part of an irregular 3D surface. If the block is rectangular, and the irregular 3D surface lies inside it, there may be some parts of the block that are “empty”, or “unoccupied”. These parts of the block do not contain any valid volumetric content, and should not be displayed to a viewer. Unfortunately, under data compression, transmission, and subsequent decompression for display, it becomes harder to discriminate which data is stored where in the block-based volumetric video and it can lead to errors that can cause unpleasant visual artifacts in a rendered output.

Accordingly, there remains a need for mitigating and/or overcoming drawbacks associated with current methods.

### SUMMARY

In view of the foregoing, embodiments herein provide a processor-implemented method for encoding a block-based volumetric video having a plurality of video frames of a 3D object into a 2D video format. The processor-implemented method includes (i) splitting each video frame of the plurality of video frames into a first region that includes RGB data, a second region that includes depth data, and at least a third region containing render metadata of the 3D object; and (ii) storing the render metadata of the 3D object in at least one of the first region that includes the RGB data, the second region that includes the depth data and the at least the third region in at least one channel that is selected from a U chroma channel, a V chroma channel, and a luma channel of the block-based volumetric video.

In some embodiments, the render metadata includes material information for rendering a surface of the 3D object.

In some embodiments, the material information includes a material property of a surface normal of a surface representation of surface data of the 3D object.

In some embodiments, the material information includes a 2D vector that represents a principal axis of anisotropy in a material of the 3D object.

In some embodiments, the material information describes at least one of a valid pixel that includes a valid volumetric content or an invalid pixel that does not include the valid volumetric content.

In some embodiments, if a magnitude of the 2D vector is above a threshold, the material of the 3D object is identified as being anisotropic, and if the magnitude of the 2D vector is equal to or below the threshold, the material of the 3D object is identified as being isotropic.

In some embodiments, the material information includes a transparency value that represents transparency data. In some embodiments, a relationship between the transparency value and whether a pixel is a valid pixel or an invalid pixel is defined by at least one of (i) if the transparency value is greater than a threshold, the pixel is a valid pixel and if the transparency value is lesser than the threshold, the pixel is an invalid pixel, or (ii) if the transparency value is lesser than the threshold, the pixel is a valid pixel and if the transparency value is greater than the threshold, the pixel is an invalid pixel. In some embodiments, a valid pixel is a fully opaque pixel. In some embodiments, a valid pixel is a partially transparent pixel. In some embodiments, an invalid pixel is a fully transparent pixel.

In some embodiments, the material information describes at least one of the valid pixel and the invalid pixel. In some embodiments, the invalid pixel is represented in a first color, and the valid pixel is represented in a second color. In some embodiments, the first color is different from the second color.

In some embodiments, the method further includes filling a pixel in the RGB data or the depth data that corresponds to the invalid pixel in the RGB data or the depth data with a selected color using an encoder. In some embodiments, the selected color is similar to a color of the valid pixel in the RGB data that is near to the pixel that corresponds to the invalid pixel in the RGB data. In some embodiments, the selected color is visually similar to a color of the valid pixel in the depth data that is near to the pixel that corresponds to the invalid pixel in the depth data. The method uses visual similar colors for two reasons. The first reason is to improve standard compression techniques like H264 that compress similar colors better than large color changes. The second reason is that in the case an invalid pixel is erroneously classified as valid due to compression artifacts, the displayed color or depth value is similar enough to valid data that it will minimize visual artifacts.

In some embodiments, the transparency data has a first resolution, the RGB data that is stored in the first region has a second resolution, and the depth data that is stored in the second region has a third resolution. In some embodiments, the first resolution of the transparency data is different from at least one of the second resolution and the third resolution.

In some embodiments, the method further includes linearly interpolating the RGB data or the depth data to generate a smoothly varying value of the RGB data or the depth data, respectively and to fetch the RGB data or the depth data at a sub-pixel location, when the transparency data is stored at least in the third region. In some embodiments, the sub-pixel location of the RGB data or the depth data represents at least one of an x coordinate or a y coordinate. The x coordinate and they coordinate may include an integer value or a non-integer value.

In some embodiments, the render metadata includes an alpha value that represents transparency of at least one of the valid pixel or the invalid pixel. In some embodiments, the alpha value is stored in the at least the third region in the previously unused channel or in the luma channel.

In one aspect, a system for encoding a block-based volumetric video having a plurality of video frames of a 3D object into a 2D video format is provided. The system includes a memory that stores a set of instructions and a processor that executes the set of instructions and is configured to perform a method including: (i) splitting each video frame of the plurality of video frames into a first region that includes RGB data, a second region that includes depth data, and at least a third region containing render metadata of the 3D object and (ii) storing the render metadata of the 3D object in at least one of the first region that includes the RGB data, the second region that includes the depth data and the at least the third region in at least one channel that is selected from a U chroma channel, a V chroma channel, and a luma channel of the block-based volumetric video.

In some embodiments, the render metadata includes material information for rendering a surface of the 3D object.

In some embodiments, the material information includes a material property of a surface normal of a surface representation of surface data of the 3D object.

In some embodiments, the material information includes a 2D vector that represents a principal axis of anisotropy in a material of the 3D object.

In some embodiments, the material information describes at least one of a valid pixel that includes a valid volumetric content or an invalid pixel that does not include the valid volumetric content.

In some embodiments, the material information includes a transparency value that represents transparency data. In some embodiments, a relationship between the transparency value and whether a pixel is a valid pixel or an invalid pixel is defined by at least one of (i) if the transparency value is greater than a threshold, the pixel is a valid pixel and if the transparency value is lesser than the threshold, the pixel is an invalid pixel, or (ii) if the transparency value is lesser than the threshold, the pixel is a valid pixel and if the transparency value is greater than the threshold, the pixel is an invalid pixel. In some embodiments, a valid pixel is a fully opaque pixel. In some embodiments, a valid pixel is a partially transparent pixel. In some embodiments, an invalid pixel is a fully transparent pixel.

In some embodiments, the material information describes at least one of the valid pixel and the invalid pixel. In some embodiments, the invalid pixel is represented in a first color, and the valid pixel is represented in a second color. In some embodiments, the first color is different from the second color.

In another aspect, one or more non-transitory computer readable storage mediums storing one or more sequences of instructions, which when executed by one or more processors, causes a processor-implemented method for encoding a block-based volumetric video having a plurality of video frames of a 3D object into a 2D video format is provided. The method includes (i) splitting each video frame of the plurality of video frames into a first region that includes RGB data, a second region that includes depth data, and at least a third region containing render metadata of the 3D object and (ii) storing the render metadata of the 3D object in at least one of the first region that includes the RGB data, the second region that includes the depth data and the at least the third region in at least one channel that is selected from a U chroma channel, a V chroma channel, and a luma channel of the block-based volumetric video.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates encoding a block-based volumetric video having a plurality of video frames of a 3D object in a global digital space into a 2D video format according to some embodiments herein;

FIG. 2 is an exemplary view that illustrates at least one channel that is selected from a U chroma channel, a V chroma channel, and a luma channel of a block-based volumetric video according to some embodiments herein;

FIG. 3A exemplarily illustrates a tiled-video frame that includes transparency data embedded in RGB data of a first region according to some embodiments herein;

FIG. 3B exemplarily illustrates a tiled-video frame that includes transparency data that is stored in at least a third region in a previously unused channel according to some embodiments herein;

FIG. 4A exemplarily illustrates classification of colors into a valid color and an invalid color when the transparency data is embedded in the RGB data that is stored in the first region according to some embodiments herein;

FIG. 4B exemplarily illustrates classification of colors into a valid color and an invalid color when the transparency data is stored in at least the third region in the previously unused channel according to some embodiments herein;

FIG. 5A exemplarily illustrates an uncompressed block-based volumetric video of a 3D object according to some embodiments herein;

FIG. 5B exemplarily illustrates a compressed block-based volumetric video of the 3D object and the transparency data is embedded in the RGB data of the first region according to some embodiments herein;

FIG. 5C exemplarily illustrates the compressed block-based volumetric video of the 3D object and the transparency data is stored in at least the third region in the previously unused channel according to some embodiments herein;

FIG. 6 is a flow diagram that illustrates a method of encoding a block-based volumetric video having a plurality of video frames of a 3D object into a 2D video format according to some embodiments herein;

FIG. 7 is a flow diagram that illustrates a method of encoding transparency data for each block in a block-based volumetric video according to some embodiments herein;

FIG. 8 is a flow diagram that illustrates a method of storing material information in at least a third region in at least one channel according to some embodiments herein;

FIG. 9 is a flow diagram that illustrates a method of storing transparency data in at least a third region in a previously unused channel according to some embodiments herein; and

FIG. 10 is a schematic diagram of a computer architecture in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

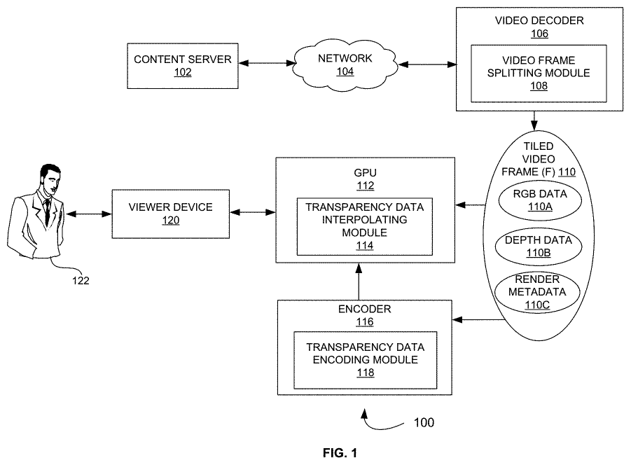

There remains a need for a more efficient method for mitigating and/or overcoming drawbacks associated with current methods. Referring now to the drawings, and more particularly to FIGS. 1 through 10, where similar reference characters denote corresponding features consistently throughout the figures, there are shown preferred embodiments.

FIG. 1 is a block diagram 100 that illustrates encoding a block-based volumetric video having a plurality of video frames of a 3D object in a global digital space into a 2D video format according to some embodiments herein. The block diagram 100 includes a content server 102, a network 104, a video decoder 106 that includes a video frame splitting module 108, a tiled video frame (F) 110, a Graphics Processing Unit (GPU) 112 that includes a transparency data interpolating module 114, an encoder 116 that includes a transparency data encoding module 118 and a viewer device 120 associated with a viewer 122.

In some embodiments, the content server 102 is implemented as a Content Delivery Network (CDN), e.g., an Amazon® CloudFront®, Cloudflare®, Azure® or an Edgecast® Content Delivery Network. In some embodiments, the content server 102 is associated with an online video publisher, e.g., YouTube by Google, Inc., Amazon Prime Video by Amazon, Inc., Apple TV by Apple, Inc., Hulu and Disney Plus by The Walt Disney Company, Netflix by Netflix, Inc., CBS All Access by ViacomCBS, Yahoo Finance by Verizon Media, etc., and/or an advertiser, e.g., Alphabet, Inc, Amazon Inc, Facebook, Instagram, etc. In some embodiments, the content server 102 is associated with a media company, e.g., Warner Media, News Corp, The Walt Disney Company, etc. In some embodiments, the content server 102 is a video conferencing server, e.g. a Jitsi or Janus Selective Forwarding Unit (SFU).

A partial list of devices that are capable of functioning as the content server 102, without limitation, may include a server, a server network, a mobile phone, a Personal Digital Assistant (PDA), a tablet, a desktop computer, or a laptop. In some embodiments, the network 104 is a wired network. In some embodiments, the network 104 is a wireless network. In some embodiments, the network 104 is a combination of the wired network and the wireless network. In some embodiments, the network 104 is the Internet.

The video decoder 106 may be part of a mobile phone, a headset, a tablet, a television, etc. The viewer device 120, without limitation, may be selected from a mobile phone, a gaming device, a Personal Digital Assistant, a tablet, a desktop computer, or a laptop.

The video decoder 106 receives a volumetric video from the content server 102 through the network 104. In some embodiments, the content server 102 delivers a 3 Dimensional (3D) content. In some embodiments, the 3D content is a 3D asset or a 3D video.

The video frame splitting module 108 of the video decoder 106 splits each video frame (F) 110 of the plurality of video frames into a first region, a second region, and at least a third region. The first region includes (Red, Green, and Blue) RGB data 110A, the second region includes depth data 110B, and the at least the third region containing render metadata 110C of the 3D object. The video frame splitting module 108 of the video decoder 106 then transmits the RGB data 110A, the depth data 110B, and the render metadata 110C to the GPU 112 and the encoder 116. In some embodiments, the 3D object is selected from, without limitation, any of a synthetic data object, a human being, animal, a natural scenery, etc.

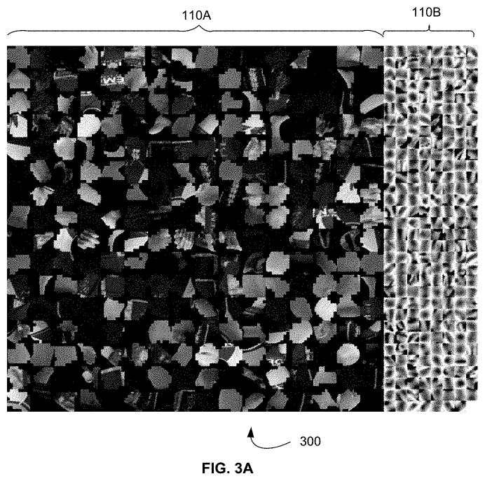

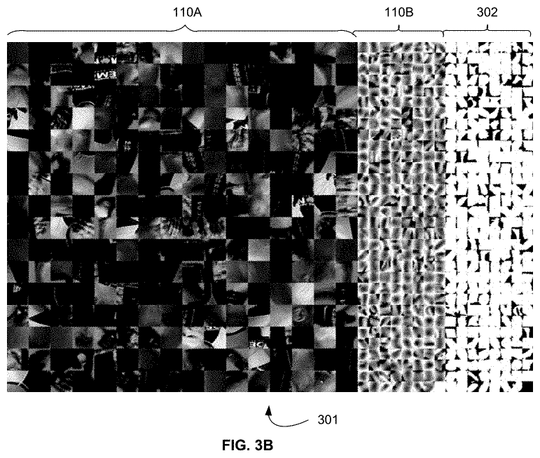

In some embodiments, the RGB data 110A stores a color image for each block and represents a color of a 3D surface within a block. In some embodiments, the depth data 110B stores a grayscale image for each block and represents a 3D shape of the 3D surface within the block. In some embodiments, the depth data 110B represents the 3D shape of the 3D surface as a height-field. The depth data 110B may be encoded as a grayscale video in a luma channel. In some embodiments, the video frame is 1536×1024 pixels. In some embodiments, there are 255 tiles, each of which has RGB, depth, and transparency components. In some embodiments, RGB data has a 64×64 resolution while the depth data 110B and transparency data have a 32×32 resolution. One such example is shown in FIG. 3B.

In some embodiments, the render metadata 110C includes material information for rendering a surface of the 3D object. The render metadata 110C may be information that is necessary for rendering the surface of the 3D object. In some embodiments, the material information includes a material property of a surface normal of a surface representation of surface data of the 3D object. In some embodiments, the material property includes at least one of unit-length or a direction of the surface normal. The material information of a material of the 3D object, or the unit-length of the surface normal of the surface representation may be encoded in an unused U chroma channel and an unused V chroma channel.

In some embodiments, the surface representation includes a 2D surface that is embedded in 3 dimensions. In some embodiments, the surface representation includes the 2D surface that is parameterized in a rectangular grid. In some embodiments, the surface representation is parameterized in 2 dimensions as a depth map with color data.

In some embodiments, the material information includes a 2D vector that represents a principal axis of anisotropy in a material of the 3D object. For example, the material information may be a 2D parameterization of material properties, e.g., anisotropic specularity. In some embodiments, the 2D vector represents the principal axis of the anisotropy in the material of the 3D object is defined using a U chroma channel and a V chroma channel. In some embodiments, if a magnitude of the 2D vector is above a threshold, the material of the 3D object is identified as being anisotropic, and if the magnitude of the 2D vector is equal to or below the threshold, the material of the 3D object is identified as being isotropic.

In some embodiments, from the magnitude of zero to the threshold, the material is interpreted as going from shiny to matte, and then from the threshold to the maximum, the material is interpreted as going from matte to shiny in the direction of the 2D vector, while maintaining a constant matte reflectivity in a direction perpendicular to the 2D vector.

In some embodiments, the material information describes at least one of a valid pixel that includes a valid volumetric content or an invalid pixel that does not include the valid volumetric content.

The material information may include a transparency value that represents transparency data. In some embodiments, the transparency value that is stored in images is 8 bits. The transparency values may be mapped to floating-point values. In some embodiments, a relationship between the transparency value and whether a pixel is a valid pixel or an invalid pixel is defined by at least one of (i) if the transparency value is greater than a threshold, the pixel is a valid pixel and if the transparency value is lesser than the threshold, the pixel is an invalid pixel, or (ii) if the transparency value is lesser than the threshold, the pixel is a valid pixel and if the transparency value is greater than the threshold, the pixel is an invalid pixel. In some embodiments, a valid pixel is a fully opaque pixel. In some embodiments, a valid pixel is a partially transparent pixel. In some embodiments, an invalid pixel is a fully transparent pixel. The threshold value may be in a range of 0 to 256. In some embodiments, if the transparency data is stored in a separate channel, the threshold value may be half the range, e.g., 128.

In some embodiments, the transparency data has a first resolution, the RGB data 110A that is stored in the first region has a second resolution, the depth data 110B that is stored in the second region has a third resolution. In some embodiments, the first resolution of the transparency data is different from at least one of the second resolution and the third resolution. In some embodiments, the transparency data stored at least in the third region is stored in a previously unused channel.

The video frame splitting module 108 of the video decoder 106 stores the render metadata 110C of the 3D object in at least one of the first region that includes the RGB data 110A and the at least the third region in at least one channel that is selected from at least one of a U chroma channel, a V chroma channel, and a luma channel of the block-based volumetric video.

In some embodiments, the render metadata 110C includes an alpha value that represents transparency of at least one of the valid pixel or the invalid pixel. In some embodiments, the alpha value is stored in the at least the third region in the previously unused channel or the luma channel. In some embodiments, an alpha value is represented by 8 bits. In some embodiments, an alpha value of 255 means totally opaque, and an alpha value of 0 means totally transparent. In some embodiments, an alpha value of 240 or greater means totally opaque, and an alpha value of 16 or lesser means totally transparent. In some embodiments, an alpha value between the totally opaque and totally transparent threshold values indicates the degree of transparency.

In some embodiment, the material information describes at least one of the valid pixel and the invalid pixel. In some embodiments, the transparency data encoding module 118 of the encoder 116 represents the invalid pixel in a first color, and the valid pixel in a second color. In some embodiments, the first color is different from the second color.

In some embodiments, the transparency data encoding module 118 of the encoder 116 fills a pixel that corresponds to the invalid pixel in the RGB data 110A or the depth data 110B with a selected color. The selected color may be similar to a color of the valid pixel in the RGB data 110A that is near to the pixel that corresponds to the invalid pixel in the RGB data 110A. In some embodiments, the selected color is similar to a color of the valid pixel in the depth data 110B that is near to the pixel that corresponds to the invalid pixel in the depth data 110B.

In some embodiments, the RGB data 110A and the depth data 110B corresponding to a region of invalid pixels are filled with colors that are selected to smoothly interpolate between the RGB data 110A or the depth data 110B, respectively, corresponding to valid pixels that border the region. In some embodiments, filled values are selected using a diffusion process that minimizes magnitude of gradients between pixels in the region corresponding to the invalid pixels.

In some embodiments, if the transparency data or information on whether a pixel is valid or invalid that is stored in the at least the third region, then the encoder 116 fills the corresponding invalid pixel in the RGB data 110A or the depth data 110B with a similar color to valid values in the RGB data 110A and the depth data 110B. In some embodiments, if the transparency data or the information on whether the pixel is a valid pixel or invalid that is stored in the at least the third region, then the encoder 116 fills values in the RGB data 110A and the depth data 110B in full range.

The GPU 112 includes the transparency data interpolating module 114 that may linearly interpolate the RGB data 110A to generate a smoothly varying value of the RGB data 110A and to fetch the RGB data 110A at a sub-pixel location when the transparency data is stored in the at least the third region. Similarly, the transparency data interpolating module 114 may linearly interpolate the depth data 110B to generate a smoothly varying value of the depth data 110B and to fetch the depth data 110B at the sub-pixel location. The sub-pixel location of the RGB data 110A or the depth data 110B may represent at least one of an x coordinate or a y coordinate. In some embodiments, the x coordinate and the y coordinate include an integer value, e.g., −5, 1, 5, 8, 97 or a non-integer value, e.g., −1.43, 1¾, 3.14.

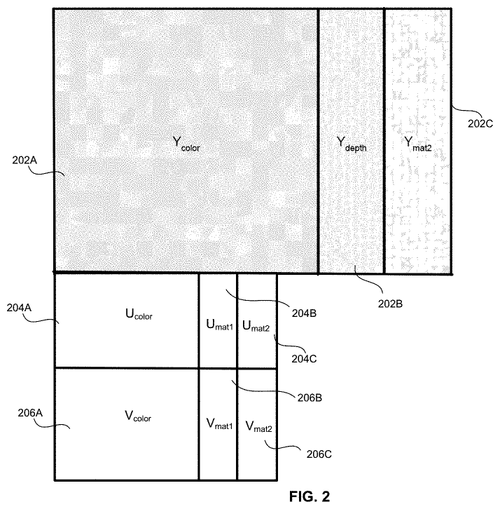

FIG. 2 is an exemplary view that illustrates at least one channel that is selected from a U chroma channel, a V chroma channel, and a luma channel of a block-based volumetric video according to some embodiments herein. In FIG. 2, the RGB data 110A that is stored in a first region, e.g., Y color 202A, the depth data 110B that is stored in a second region, e.g., Y depth 202B, and transparency data that is stored in at least a third region in a previously unused channel, e.g., Y mat2 202C. In some embodiments, the U chroma channel includes U color 204A, Umat1 204B, and Umat2 204C. In some embodiments, the V chroma channel includes Vcolor 206A, Vmat1 206B, and Vmat2 206C.

FIG. 3A exemplarily illustrates a tiled-video frame 300 that includes transparency data embedded in the RGB data 110A of a first region according to some embodiments herein. In FIG. 3A, the tiled-video frame 300 includes the transparency data embedded in the RGB data 110A of the first region and a second region that includes the depth data 110B. Similarly, in some alternative embodiments, the transparency data is embedded in the second region that includes the depth data 110B.

FIG. 3B exemplarily illustrates a tiled-video frame 301 that includes transparency data 302 that is stored in at least the third region in a previously unused channel according to some embodiments herein. In FIG. 3B, the tiled-video frame 301 includes RGB data 110A in the first region comprised of valid RGB values and interpolated RGB values in the invalid regions. Also in FIG. 3B, the tiled-video frame 301 includes depth data 110B in the second region comprised of valid depth values and interpolated depth values in the invalid regions. Also in FIG. 3B, the tiled-video frame 301 includes transparency data 302 in at least the third region in the previously unused channel such that invalid data is represented using values below a threshold and partially transparent and opaque data are represented using luma values above a threshold. In some embodiments this threshold is set to 16.

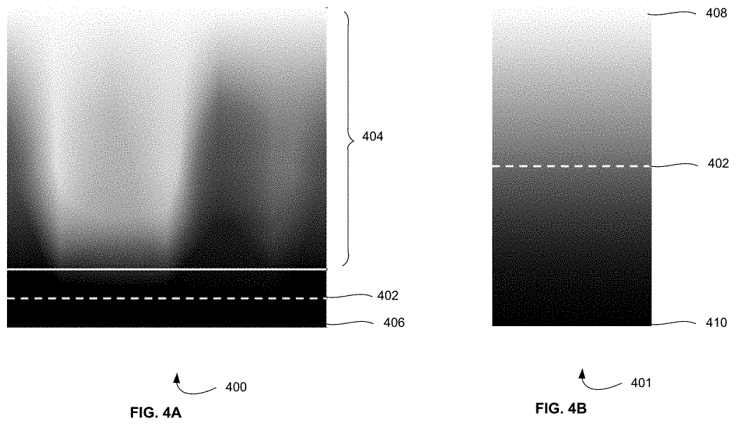

FIG. 4A exemplarily illustrates classification of colors into a valid color and an invalid color when the transparency data 302 is embedded in the RGB data 110A that is stored in a first region according to some embodiments herein. In some embodiments, if the transparency data 302 is embedded into the RGB data 110A, the GPU 112 (as shown in FIG. 1) classifies a pixel as an invalid pixel when a color of the pixel is “similar” to a selected color. In some embodiments, the GPU 112 classifies a pixel as a valid pixel when a color of the pixel is “dissimilar” to the selected color. In some embodiments, the GPU 112 classifies a pixel as an invalid pixel when the luma channel of the pixel has a value within a range of 8 from a selected nominal invalid value of 8, e.g., 0-15.

In some embodiments, a classification boundary 402 is inserted to classify the valid colors 404 and the invalid colors 406. In some embodiments, if a black color is used to indicate invalid pixels, darkest valid pixels may still be relatively close to the black color. In some embodiments, some invalid pixels may have a color that is above the classification boundary 502, and some valid pixels may have a color that is below the classification boundary 502 after compressing a block-based volumetric video. In some embodiments, if 0 is used to indicate the invalid pixels, anything less than the classification boundary of 16 may be considered invalid. In some embodiments, anything above or equal to the classification boundary of 16, e.g., 40 may be considered valid.

FIG. 4B exemplarily illustrates classification of colors into the valid color and the invalid color when the transparency data 302 is stored in at least a third region in a previously unused channel according to some embodiments herein. In some embodiments, when the transparency data 302 is stored in the at least the third region in the previously unused channel, white color 408 is to indicate a valid pixel, and black color 410 is to indicate the invalid pixel, it is less likely that a pixel's color may cross the classification boundary 502 due to compression.

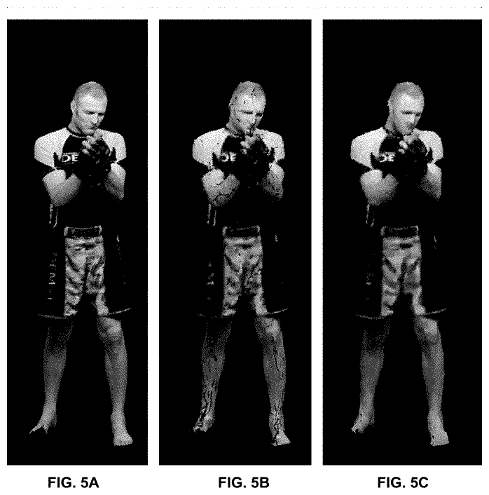

FIG. 5A exemplarily illustrates an uncompressed block-based volumetric video of a 3D object, e.g., a boxer according to some embodiments herein. The transparency data encoding module 118 of the encoder 116 (as shown in FIG. 1) represents an invalid pixel in a first color, and a valid pixel in a second color. In some embodiments, the first color is different from the second color. The transparency data encoding module 118 of the encoder 116 fills a pixel in the RGB data 110A that corresponds to the invalid pixel with a selected color. The selected color may be similar to a color of the valid pixel in the RGB data 110A that is near to the pixel that corresponds to the invalid pixel in the RGB data 110A. In some embodiments, the selected color is similar to a color of the valid pixel in the depth data 110B that is near to the pixel that corresponds to the invalid pixel in the depth data 110B.

In some embodiments, the RGB data 110A and the depth data 110B corresponding to a region of invalid pixels are filled with colors that are selected to smoothly interpolate between the RGB data 110A or the depth data 110B, respectively, corresponding to the valid pixels that border the region. In some embodiments, filled values are selected using a diffusion process that minimizes magnitude of gradients between pixels in the region corresponding to the invalid pixels.

With reference to FIG. 5A, FIG. 5B exemplarily illustrates a compressed block-based volumetric video of the 3D object, e.g., and the transparency data 302 is embedded in the RGB data 110A of the first region according to some embodiments herein. In some embodiments, if the GPU 112 (as shown in FIG. 1) incorrectly classifies an invalid pixel as a valid pixel and renders the invalid pixel, the invalid pixel may be visible in a rendered output as an incongruous spot of the selected color. In some embodiments, the selected color may be black. In FIG. 5B, where the selected color (black) is visible in the rendered output after compression.

With reference to FIG. 5A, FIG. 5C exemplarily illustrates the compressed block-based volumetric video of the 3D object, e.g., the boxer and the transparency data 302 is stored in at least the third region in a previously unused channel according to some embodiments herein. For example, the GPU 112 incorrectly classifies the invalid pixel as the valid pixel and displays the invalid pixel to the viewer 122. In some embodiments, this kind of diffusion may hide an error as an incorrectly-classified pixel may have a color that is similar to the pixel around the incorrectly-classified pixel if the transparency data 302 is stored in the at least the third region in the previously unused channel, In FIG. 5C, if the transparency data 302 is stored in the at least the third region in the previously unused channel, incorrectly-classified pixels are not visible to the viewer 122, as colors of the incorrectly-classified pixels are similar to surrounding valid pixels. Additionally in FIG. 5C, because the transparency data 302 fills the full range in at least the third region in the previously unused channel, the pixel is less likely to be incorrectly classified due to compression.

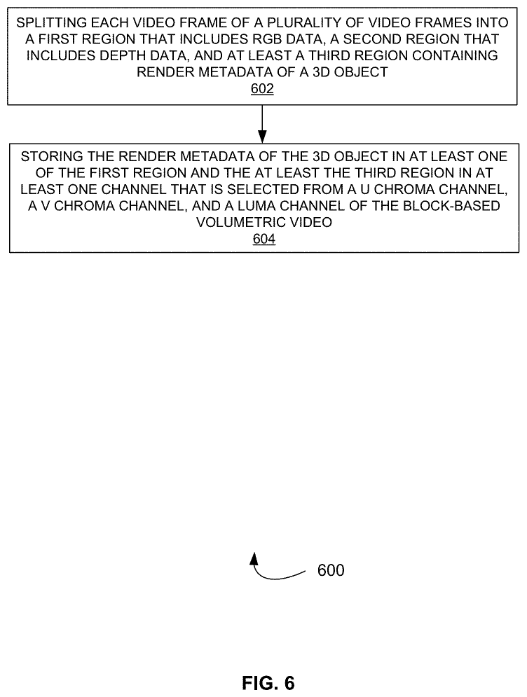

FIG. 6 is a flow diagram that illustrates a method 600 of encoding a block-based volumetric video having a plurality of video frames of a 3D object into a 2D video format according to some embodiments herein. At step 602, the method 600 includes splitting, at the video frame splitting module 108 of the video decoder 106, each video frame of the plurality of video frames into a first region that includes the RGB data 110A, a second region that includes the depth data 110B, and at least a third region containing the render metadata 110C of the 3D object, e.g., a boxer. In some embodiments, the RGB data 110A stores a color image for each block and represents a color of a 3D surface within a block. In some embodiments, the depth data 110B stores a grayscale image for each block and represents a 3D shape of the 3D surface within the block.

At step 604, the method 600 includes storing, the render metadata 110C of the 3D object in at least one of the first region that includes the RGB data 110A and the at least the third region in at least one channel that is selected from a U chroma channel, a V chroma channel, and a luma channel of the block-based volumetric video. The render metadata 110C may be information that is necessary for rendering a surface of the 3D object.

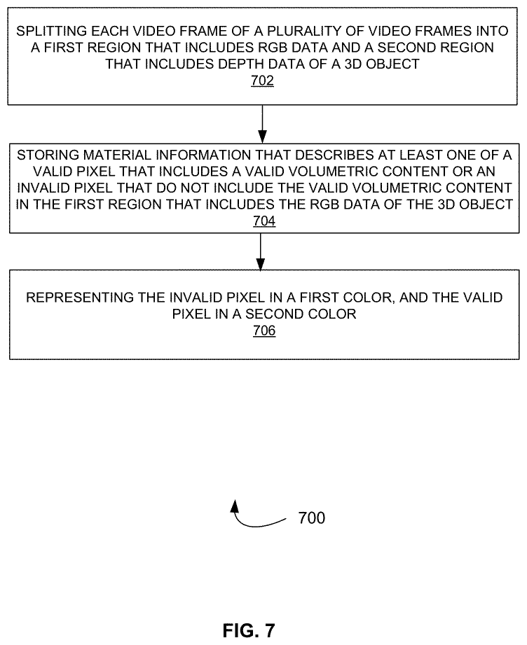

FIG. 7 is a flow diagram that illustrates a method 700 of encoding the transparency data 302 for each block in a block-based volumetric video according to some embodiments herein. At step 702, the method 700 includes splitting, at the video frame splitting module 108 of the video decoder 106, each video frame of a plurality of video frames into a first region that includes the RGB data 110A and a second region that includes the depth data 110B of a 3D object, e.g., a boxer.

At step 704, the method 700 includes storing material information that describes at least one of a valid pixel that includes a valid volumetric content or an invalid pixel that does not include the valid volumetric content in the first region that includes the RGB data 110A of the 3D object. In some embodiments, the valid pixel is fully opaque or partially transparent. In some embodiments, the invalid pixel is fully transparent or partially opaque. At step 706, the method 700 includes representing the invalid pixel in a first color, and the valid pixel in a second color. In some embodiments, the first color is different from the second color.

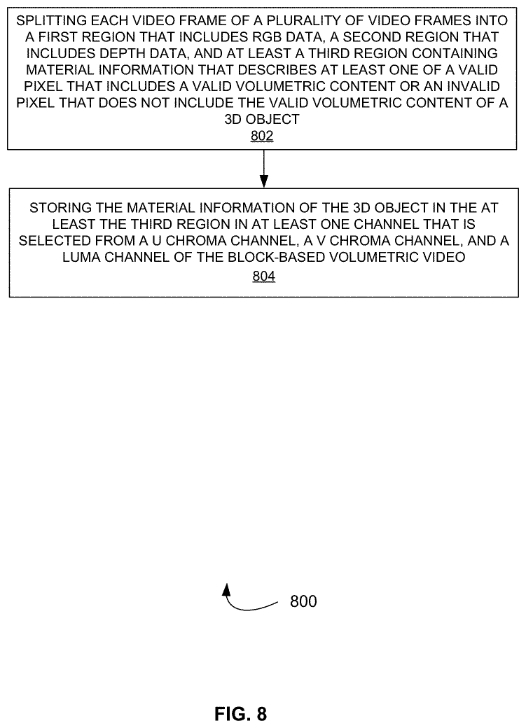

FIG. 8 is a flow diagram that illustrates a method 800 of storing material information in at least a third region in at least one channel according to some embodiments herein. At step 802, the method 800 includes splitting each video frame of a plurality of video frames into a first region that includes the RGB data 110A, a second region that includes the depth data 110B, and the at least the third region containing the material information describes at least one of a valid pixel that includes a valid volumetric content or an invalid pixel that does not include the valid volumetric content of a 3D object. At step 804, the method 800 includes storing the material information of the 3D object in the at least the third region in the at least one channel that is selected from a U chroma channel, a V chroma channel, and a luma channel of the block-based volumetric video.

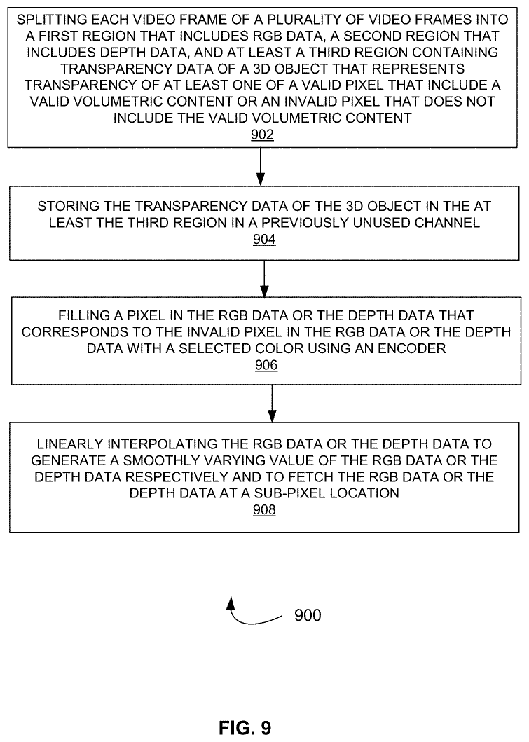

FIG. 9 is a flow diagram that illustrates a method 900 of storing the transparency data 302 in at least a third region in a previously unused channel according to some embodiments herein. At step 902, the method 900 includes splitting each video frame of a plurality of video frames into a first region that includes the RGB data 110A, a second region that includes the depth data 110B, and at least a third region containing the transparency data 302 of the 3D object that represents transparency of at least one of a valid pixel that includes a valid volumetric content or an invalid pixel that does not include the valid volumetric content. In some embodiments, the transparency data 302 has a first resolution, the RGB data 110A that is stored in the first region has a second resolution, and the depth data 110B that is stored in the second region has a third resolution. In some embodiments, the first resolution of the transparency data 302 is different from at least one of the second resolution and the third resolution.

At step 904, the method 900 includes storing the transparency data 302 of the 3D object in the at least the third region in a previously unused channel. In some embodiments, the previously unused channel is a luma channel. At step 906, the method 900 includes filling a pixel in the RGB data 110A or the depth data 110B that corresponds to the invalid pixel in the RGB data 110A or the depth data 110B with a selected color using the encoder 116 (as shown in FIG. 1). In some embodiments, the selected color is similar to a color of the valid pixel in the RGB data 110A that is near to the pixel that corresponds to the invalid pixel in the RGB data 110A. In some embodiments, the selected color is similar to a color of the valid pixel in the depth data 110B that is near to the pixel that corresponds to the invalid pixel in the depth data 110B. For example, the GPU 112 (as shown in FIG. 1) incorrectly classifies the invalid pixel as the valid pixel and displays the invalid pixel to the viewer 122. In some embodiments, this kind of diffusion may hide an error as an incorrectly classified pixel may have a color that is similar to pixels around the incorrectly classified pixel if the transparency data 302 is stored in the at least the third region in the previously unused channel. In some embodiments, if the transparency data 302 is stored in the at least the third region in the previously unused channel, incorrectly classified pixels are not visible, because their colors are similar to surrounding valid pixels.

At step 908, the method 900 includes linearly interpolating the RGB data 110A or the depth data 110B to generate a smoothly varying value of the RGB data 110A or the depth data 110B, respectively and to fetch the RGB data 110A or the depth data 110B at a sub-pixel location when the transparency data 302 is stored in the at least the third region. The sub-pixel location of the RGB data 110A or the depth data 110B may represent at least one of an x coordinate or a y coordinate. In some embodiments, the x coordinate and the y coordinate include an integer value or a non-integer value.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

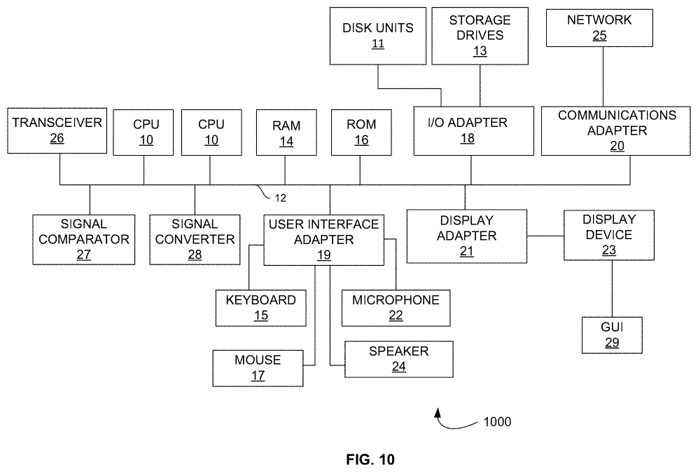

A representative hardware environment for practicing the embodiments herein is depicted in FIG. 10, with reference to FIGS. 1 through 9. This schematic drawing illustrates a hardware configuration of a server/computer system/user device in accordance with the embodiments herein. The viewer device 120 includes at least one processing device 10 and a cryptographic processor 11. The special-purpose CPU 10 and the cryptographic processor (CP) 11 may be interconnected via system bus 14 to various devices such as a random access memory (RAM) 15, read-only memory (ROM) 16, and an input/output (I/O) adapter 17. The I/O adapter 17 can connect to peripheral devices, such as disk units 12 and tape drives 13, or other program storage devices that are readable by the system. The viewer device 120 can read the inventive instructions on the program storage devices and follow these instructions to execute the methodology of the embodiments herein. The viewer device 120 further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing network 26, and a display adapter 22 connects the bus 14 to a display device 24, which provides a graphical user interface (GUI) 30 of the output data in accordance with the embodiments herein, or which may be embodied as an output device such as a monitor, printer, or transmitter, for example. Further, a transceiver 27, a signal comparator 28, and a signal converter 29 may be connected with the bus 14 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method for encoding a block-based volumetric video having a plurality of video frames of a 3D object into a 2D video format, comprising:
splitting each video frame of the plurality of video frames into a first region that comprises RGB data, a second region that comprises depth data, and at least a third region containing render metadata of the 3D object; and
storing the render metadata of the 3D object in at least one of the first region that comprises the RGB data, the second region that comprises the depth data and the at least the third region in at least one channel that is selected from a U chroma channel, a V chroma channel, and a luma channel of the block-based volumetric video.

2. The processor-implemented method of claim 1, wherein the render metadata comprises material information for rendering a surface of the 3D object.

3. The processor-implemented method of claim 2, wherein the material information comprises a material property of a surface normal of a surface representation of surface data of the 3D object.

4. The processor-implemented method of claim 3, wherein the material information comprises a 2D vector that represents a principal axis of anisotropy in a material of the 3D object.

5. The processor-implemented method of claim 2, wherein the material information describes at least one of a valid pixel that comprises a valid volumetric content or an invalid pixel that does not comprise the valid volumetric content.

6. The processor-implemented method of claim 4, wherein if a magnitude of the 2D vector is above a threshold, then the material of the 3D object is identified as being anisotropic, and if the magnitude of the 2D vector is equal to or below the threshold, the material of the 3D object is identified as being isotropic.

7. The processor-implemented method of claim 5, wherein the material information comprises a transparency value that represents transparency data, wherein a relationship between the transparency value and whether a pixel is a valid pixel or an invalid pixel is defined by at least one of (i) if the transparency value is greater than a threshold, the pixel is a valid pixel and if the transparency value is lesser than the threshold, the pixel is an invalid pixel, or (ii) if the transparency value is lesser than the threshold, the pixel is a valid pixel and if the transparency value is greater than the threshold, the pixel is an invalid pixel, wherein the valid pixel is a fully opaque or partially transparent pixel, wherein the invalid pixel is a fully transparent pixel.

8. The processor-implemented method of claim 1, wherein the material information describes at least one of the valid pixel and the invalid pixel, wherein the invalid pixel is represented in a first color, and the valid pixel is represented in a second color, wherein the first color is different from the second color.

9. The processor-implemented method of claim 5, further comprising filling a pixel in the RGB data or the depth data that corresponds to the invalid pixel in the RGB data or the depth data with a selected color using an encoder, wherein the selected color is similar to a color of the valid pixel in the RGB data that is near to the pixel corresponds to the invalid pixel in the RGB data, wherein the selected color is similar to a color of the valid pixel that is near to the pixel corresponds to the invalid pixel in the depth data.

10. The processor-implemented method of claim 7, wherein the transparency data has a first resolution, the RGB data that is stored in the first region has a second resolution, and the depth data that is stored in the second region has a third resolution, wherein the first resolution of the transparency data is different from at least one of the second resolution and the third resolution.

11. The processor-implemented method of claim 2, further comprising when the transparency data is stored in the at least the third region, linearly interpolating the RGB data or the depth data to generate a smoothly varying value of the RGB data or the depth data, respectively, and to fetch the RGB data or the depth data at a sub-pixel location, wherein the sub-pixel location of the RGB data or the depth data represents at least one of an x coordinate or a y coordinate, wherein the x coordinate and the y coordinate comprise an integer value or a non-integer value.

12. The processor-implemented method of claim 2, wherein the render metadata comprises an alpha value that represents transparency of at least one of the valid pixel or the invalid pixel, wherein the alpha value is stored in the at least the third region in the previously unused channel or in the luma channel.

13. A system for encoding a block-based volumetric video having a plurality of video frames of a 3D object into a 2D video format comprising:
a memory that stores a set of instructions; and
a processor that executes the set of instructions and is configured to perform a method comprising:
splitting each video frame of the plurality of video frames into a first region that comprises RGB data, a second region that comprises depth data, and at least a third region containing render metadata of the 3D object; and
storing the render metadata of the 3D object in at least one of the first region that comprises the RGB data, the second region that comprises the depth data and the at least the third region in at least one channel that is selected from a U chroma channel, a V chroma channel, and a luma channel of the block-based volumetric video.

14. The system of claim 13, wherein the render metadata comprises material information for rendering a surface of the 3D object.

15. The system of claim 14, wherein the material information comprises a material property of a surface normal of a surface representation of surface data of the 3D object.

16. The system of claim 15, wherein the material information comprises a 2D vector that represents a principal axis of anisotropy in a material of the 3D object.

17. The system of claim 14, wherein the material information describes at least one of a valid pixel that comprises a valid volumetric content or an invalid pixel that does not comprise the valid volumetric content.

18. The system of claim 17, wherein the material information comprises a transparency value that represents transparency data, wherein a relationship between the transparency value and whether a pixel is a valid pixel or an invalid pixel is defined by at least one of (i) if the transparency value is greater than a threshold, the pixel is a valid pixel and if the transparency value is lesser than the threshold, the pixel is an invalid pixel, or (ii) if the transparency value is lesser than the threshold, the pixel is a valid pixel and if the transparency value is greater than the threshold, the pixel is an invalid pixel, wherein the valid pixel is a fully opaque or partially transparent pixel, wherein the invalid pixel is a fully transparent.

19. The system of claim 16, wherein the material information describes at least one of the valid pixel and the invalid pixel, wherein the invalid pixel is represented in a first color, and the valid pixel is represented in a second color, wherein the first color is different from the second color.

20. One or more non-transitory computer readable storage mediums storing one or more sequences of instructions, which when executed by one or more processors, causes a processor-implemented method for encoding a block-based volumetric video having a plurality of video frames of a 3D object into a 2D video format, the method comprising:
splitting each video frame of the plurality of video frames into a first region that comprises RGB data, a second region that comprises depth data, and at least a third region containing render metadata of the 3D object; and
storing the render metadata of the 3D object in at least one of the first region that comprises the RGB data, the second region that comprises the depth data and the at least the third region in at least one channel that is selected from a U chroma channel, a V chroma channel, and a luma channel of the block-based volumetric video.
